(19) United States
(12) Patent Application Publication
(10) Pub. No.: US 2011/0309903 A1
(43) Pub. Date: Dec. 22, 2011

(54) ELECTRIC COMPONENT AND METHOD FOR PRODUCING AN ELECTRIC COMPONENT

(75) Inventor: Joerg Findeisen, Dresden (DE)

(73) Assignee: SIEMENS AKTIENGESELLSCHAFT, MUENCHEN (DE)

(21) Appl. No.: 13/203,514

(22) PCT Filed: Feb. 27, 2009
(86) PCT No.: PCT/EP2009/001606

§ 371 Date: Aug. 26, 2011

(51) Int. Cl. H01F 27/22; H01R 43/00; B82Y 99/00

(52) U.S. Cl. 336/61; 29/825; 977/833; 977/902

(57) ABSTRACT

An electric component contains an electric conductor, wherein inside the electric conductor a current path having a current flow direction is specified because of the ends of the electric conductor being connected to two electric connection points inside the electric component. By using a mixture made of carbon nanostructures having a preferred orientation with respect to the electric conductivity along the current flow direction, and a mixture made of nanostructures having a preferred orientation with respect to the thermal conductivity on at least one of the outside surfaces of the electric component, the electric component, in particular a transformer coil, can be produced in a more compact fashion, wherein at the same time sufficient thermal conductivity of the electric component is ensured. A method for producing the electric component having such a conductor is also disclosed.

The invention relates to an electric component comprising an electric conductor, wherein inside the electric conductor a current path having a current flow direction is specified because of the ends of the electric conductor being connected to two electric connection points inside the electric component. The invention further relates to a method for producing an electric component comprising a conductor.

The production of an electric component, especially of a transformer having a winding as the electric conductor, requires a high expenditure of material and production. The electric conductors of the electric component are conventionally produced from an electrically conductive copper wire or from an aluminum foil. The processing and production expenditure for producing the electric conductor and for inserting the electric conductor into the electric component is very high.

Furthermore, the thermal characteristics of the electric component, such as heat generation and delivery during its operation, must be taken into consideration in the production and fabrication of the electric component. The heat produced during the operation of the electric component is allowed for by means of known cooling configurations for electric components, particularly transformers. In particular by using heat-conducting materials around the heat-generating windings and inserting vertical cooling ducts within the electric component, an environmental medium can circulate within and outside the electric component and the electric component can thus deliver heat to the environmental medium.

Within the context of the design and manufacture of electric components, the electric characteristics of the electric conductor of the electric component are also of decisive significance. In the prior art, some exchange materials for the electric conductor, such as, for example, copper or aluminum, are known which have a similar or better electric conductivity as copper or aluminum windings.

Thus, for example EP 1 275 118 B1 describes a power cable which has electrically conductive nanostructures and by this means provides for an electric conductivity of the power cable.

Furthermore, EP 1 246 205 A1 describes an electrically conductive nanocomposite material. Due to an intrinsic nanostructure matrix within a polymer, an electrically conductive composite is created according to the aforementioned patent application.

The problematic factor in the solutions of the prior art is that, although the electric components produced with nanostructures have an electric conductivity, they do not provide a solution for removing the heat produced during the operation of the electric component. In the case of a construction of the electric component of reduced size, in particular, an associated increased heat development with poorer thermal conductivity characteristics is produced due to the possible more compact construction of the electric component.

It is the object of the present invention, therefore, to provide an electric component and a method for producing an electric component which allows for a construction of reduced size in comparison with conventional electric components with, at the same time, improved heat removal.

The object is achieved by an electric component having the features of patent claim 1.

The object is also achieved by a method for producing an electric component according to the features of patent claim 13.

According to the invention, it is provided that the electric conductor exhibits a mixture of carbon nanostructures having a preferred orientation with respect to the electric conductivity along the current flow direction and the heat produced during the operation of the electric conductor can be removed to at least one outside surface of the electric component by means of an inner part, the inner part comprising a mixture of nanostructures having a preferred orientation with respect to the thermal conductivity to at least one of the outside surfaces of the electric component.

In the context of the present invention, current flow direction is understood to be the path of an electron within the electric conductor from a first connection point to a second connection point within the electric conductor. Nanostructures in the context of the present invention can be, apart from carbon nanostructures, also other nanostructures such as, for example, boron nitride nanostructures.

By means of the connection of carbon nanostructures having a preferred orientation with respect to the electric conductivity along the current flow direction in combination with a nanostructure having a preferred orientation of the thermal conductivity to at least one of the outside surfaces of the electric component, the electric component can be designed to be smaller and, at the same time, the associated increased or poorer heat delivery can be allowed for by an overall improved thermal conductivity of the inner part and thus of the electric component.

The inner part of the electric component advantageously encloses the electric conductor at least partially. As a result, the heat transfer from the electric conductor to the inner part and thus to one of the outside surfaces of the electric component is improved. In an advantageous embodiment of the electric component it is provided that the inner part electrically insulates the electric conductor at least partially. In this case, the inner part of the electric component serves not only as connection for heat delivery to at least one of the outside surfaces of the electric component but, at the same time, serves for electrically insulating the electric conductor on the basis of a nanostructure. When using the inner part as insulator, there is no additional expenditure for the insulation of the electric conductor.

To reduce electromagnetic radiation of the electric component, it is provided that the inner part comprises a semiconducting shielding arranged around the electric conductor. By inserting an electromagnetic shielding around the electric conductor, an effective electromagnetic shielding of the electric conductor can be provided.

In an advantageous embodiment of the electric component, it is provided that the inner part forms at least one of the outside surfaces of the electric component and has a structured surface for the improved heat delivery to the environmental medium. The formation of ribs and wavy surfaces, in particular, serves to enlarge the heat-delivering surface and thus improves the heat delivery by the electric component to the environmental medium.

At least one of the outside surfaces of the electric component is advantageously coated with a nanostructure having moisture- and/or dirt-repelling characteristics. Due to a moisture- and/or dirt-repelling coating, the electric component, particularly the transformer, can also be operated in moist and dirt-prone environments. The inner part advantageously comprises a polymer, wherein the mixture of carbon nanostructures and/or nanostructures can be inserted in the polymer. Thus, the carbon nanostructures can be inserted into the polymer with a preferred orientation with respect to the electric conductivity, and a mixture of nanostructures can be inserted into the polymer with a preferred orientation with respect to the thermal conductivity. An outside surface of the electric component in direct contact with the inner part can also have a moisture- and/or dirt-repelling nanostructure. The use of a foil as polymer, in particular, can be applied to the inner part so that the electrically conductive and/or thermally conductive and/or moisture-/dirt-repelling characteristics of the carbon nanostructures and/or nanostructures can be applied, particularly adhesively bonded, to the inner part.

In an advantageous embodiment of the electric component, it is provided that the electric conductor consists exclusively of a mixture of carbon nanostructures having a preferred orientation with respect to the electric conductivity along the current flow direction. Due to the exclusive use of carbon nanostructures, it is possible to omit the previously conventionally used conductor materials such as copper and aluminum.

The concentration of the mixture of carbon nanostructures and/or nanostructures advantageously varies within the conductor of the electric component. This provides the adaptability of the concentration and orientation of the mixture of carbon nanostructures and/or nanostructures to the required current density and/or heat flow density.

It is considered to be an advantage that the concentration of the mixture of carbon nanostructures and/or nanostructures is increased in mechanically loaded regions within the conductor. This provides the advantage that due to the good mechanical strength characteristics of the carbon nanostructures and/or the nanostructures, mechanical forces occurring can be easily absorbed or forwarded within the conductor. Short-term high short-circuit forces within the conductor, in particular, can be absorbed by corresponding concentration of the mixture of carbon nanostructures and/or nanostructures and any damage of the conductor or even of the electric component can thus be avoided. Furthermore, mechanical tensioning elements can be formed within the conductor by means of a selected concentration of the mixture of carbon nanostructures and/or nanostructures and thus static forces such as, for example, weight, can be passed on to mounting elements located outside the conductor.

According to the invention, it is also provided that the heat produced during the operation in the electric conductor consisting of carbon nanostructures with a preferred orientation with respect to the electric conductivity along the current flow direction can be removed to at least one outside surface of the electric component by means of an inner part, the inner part being formed of a mixture of nanostructures having a preferred orientation with respect to the thermal conductivity to at least one of the outside surfaces of the electric component.

In an advantageous embodiment of the method, it is provided that the electric conductor is embedded into a carrier structure, particularly a polyamide structure, the mixture of nanostructures having a preferred orientation of the thermal conductivity at least in contact with one of the outside surfaces of the electric component being embedded into the carrier structure.

The mixture of carbon nanostructures and/or nanostructures is advantageously embedded into the carrier structure, especially into a polyamide, by means of electrophoresis. By means of the electrophoresis method, the concentration and the local distribution of the carbon nanostructures and/or nanostructures within the carrier structure can be specified selectively and very accurately. Advantageously, a semi-conducting shielding is also integrated into the carrier structure as a component of the inner part.

Further advantageous embodiments are found in the subclaims. The figures show:

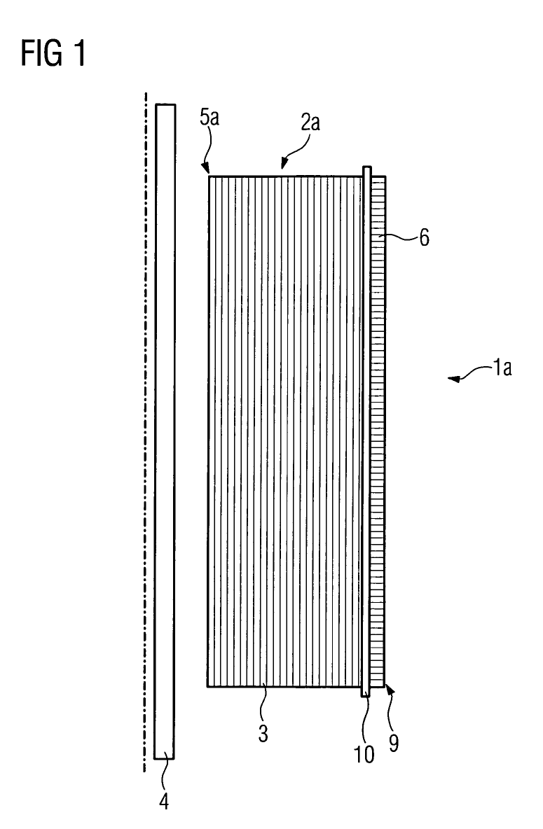

FIG. 1 a half-sided sectional drawing of a transformer as electric component having two separate nanostructures;

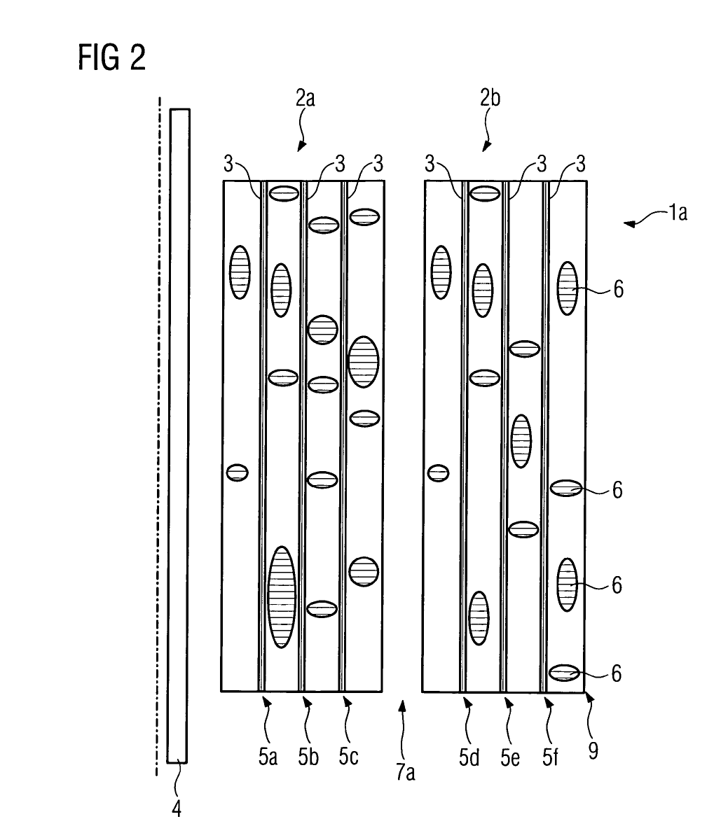

FIG. 2 a half-sided sectional drawing of an electric component having two inner parts and combined nano-structures;

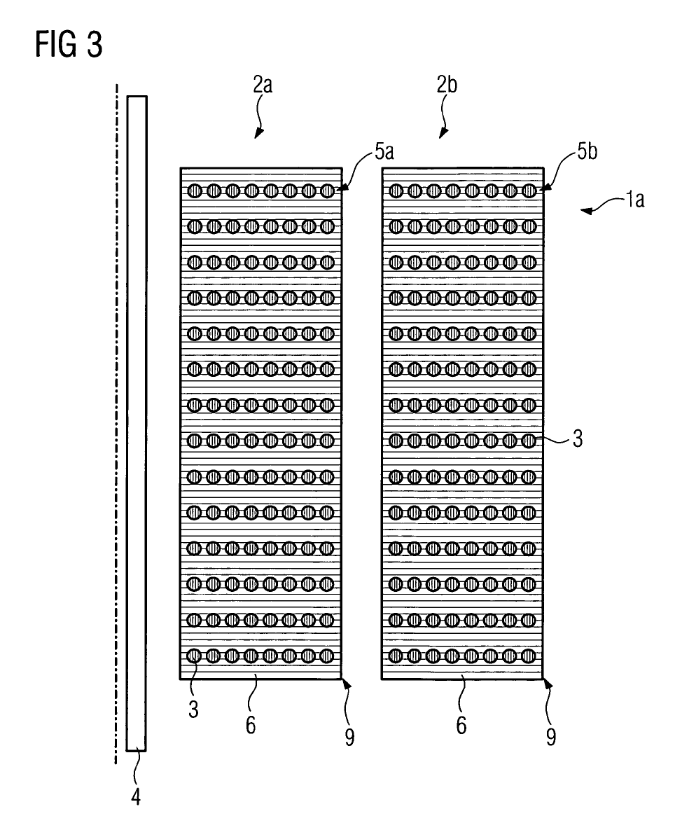

FIG. 3 a half-sided sectional drawing having two inner parts and combined electric windings and thermally conductive nanostructures;

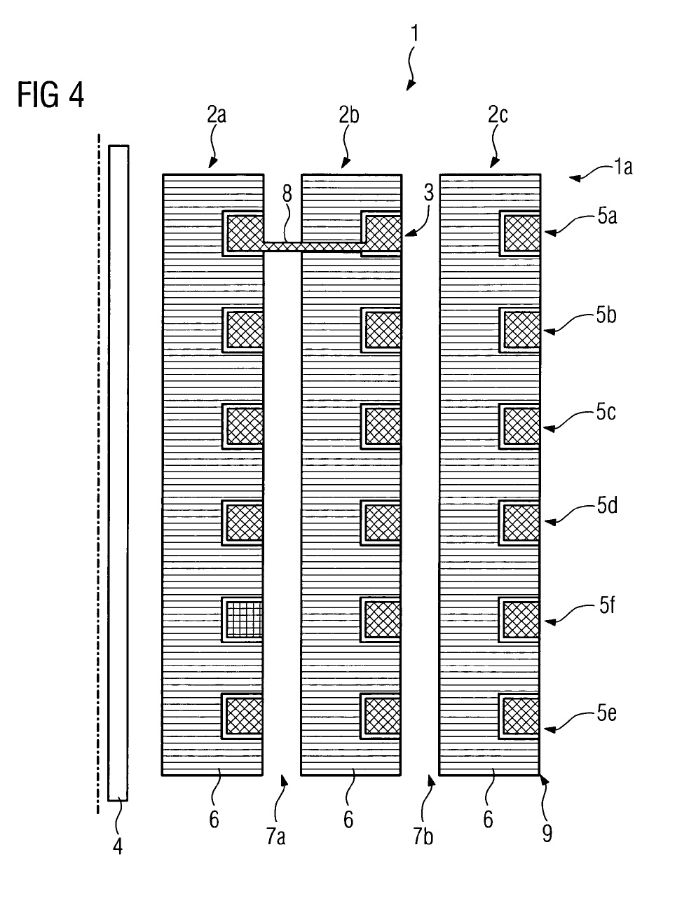

FIG. 4 a half-sided sectional drawing having three inner parts and defined electrically and thermally conductive nanostructures;

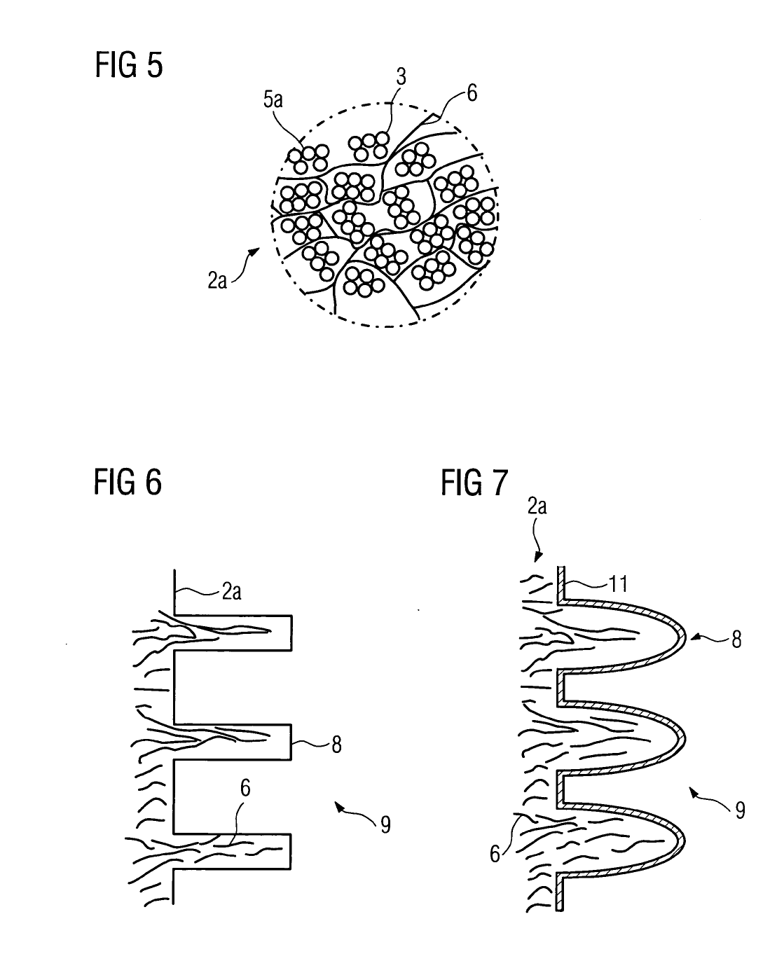

FIG. 5 a representation of the electrically and thermally conductive microscopic nanostructures within the inner part;

FIG. 6 a sectional drawing of the surface structure on one of the outside surfaces of the electric component;

FIG. 7 a sectional drawing of the surface structure having a dirt-repelling nanostructure coating on one of the outside surfaces of the electric component;

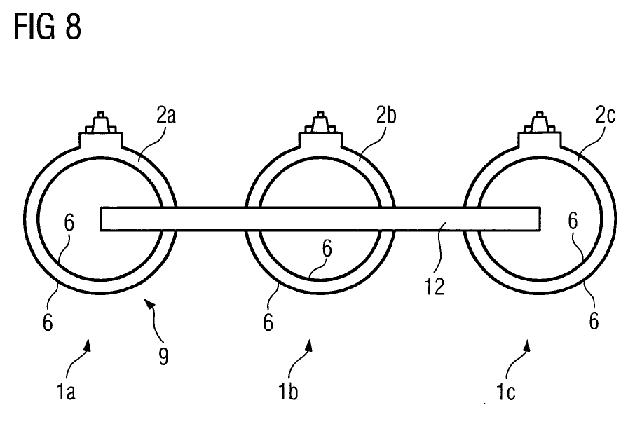

FIG. 8 a top view of three electric components combined to form a three-phase transformer.

FIG. 1 shows a half-sided sectional drawing of a transformer as electric component 1a comprising a carbon nanostructure 3 and a nanostructure 6. The line of intersection which is indicated as a dashed line extends through a core 4 of the transformer 1a. An inner part 2a has a structure which is electrically conductive in layers. An electrically conductive layer is drawn by way of example as electric conductor 5a in FIG. 1. The individual electrically conductive layers are separated from one another by insulating layers, this layered structure of the inner part 2a being implemented within a matrix comprising a mixture of carbon nanostructures 3 having a preferred orientation with respect to the electric conductivity along the current flow direction.

The conductors 5a, turns or winding parts formed from the carbon nanostructures 3 are preferably embedded in a polyamide. The inner part 2a comprises a semiconducting shielding 10. This is followed by a layer of a mixture of nanostructures 6 having a preferred orientation with respect to the thermal conductivity to at least one of the outside surfaces 9 of the electric component 1a, 1b, 1c of the inner part 2a. Preferably, a mixture of nanostructures 6 having low electric but high thermal conductivity is used, for example boron nitride carbon nanostructures.

FIG. 2 shows a half-sided sectional drawing of an electric component 1a having two inner parts 2a, 2b and combined carbon nanostructure 3 and nanostructure 6. The inner parts 2a, 2b have a layered structure of the electric conductors 5a, 5b, 5c, 5d, 5e, 5f of a mixture of carbon nanostructures 3 having a preferred orientation with respect to the electric conductivity along the current flow direction. Between the electric conductors 5a, 5b, 5c, 5d, 5e, 5f, a mixture of nanostructures 6 having a preferred orientation with respect to the thermal conductivity to at least one of the outside surfaces 9 of the electric component 1a, 1b, 1c is comprised. Between the inner parts 2a, 2b, a cooling duct 7a is arranged for additional cooling of the electric components 2a, 2b.

FIG. 3 shows a half-sided sectional drawing having two inner parts 2a, 2b and combined electric windings 5a, 5b and thermally conductive nanostructures 6 of an electric component la. Within a matrix of thermally conductive nanostructures 6, winding conductors 5a, 5b having electrically conductive carbon nanostructures 3 are embedded.

FIG. 4 shows a half-sided sectional drawing having three inner parts 2a, 2b, 2c and defined electrically and thermally conductive carbon nanostructure 3 with nanostructure 6. The inner parts 2a, 2b, 2c are designed as cylinders and consist of a mixture of thermally conductive nanostructures 6. The cylinders have pockets towards one of the outside surfaces 9 of the electric component 1a into which the mixture of electrically conductive carbon nanostructures 3 is inserted and thus forms an electric conductor 5a, 5b, 5c, 5d, 5e, 5f. The electric windings 5a, 5b, 5c, 5d, 5e, 5f, thus formed, of the individual inner part 2a, 2b, 2c can be electrically connected by means of electric connectors 8. The individual inner parts 2a, 2b, 2c are spaced apart from one another so that the intermediate spaces thus produced serve as cooling ducts 7a, 7b.

FIG. 5 shows a representation of the electrically and thermally conductive microscopic carbon nanostructure 3 with nanostructure 6 within the inner part 2a. Conductors or winding parts 5a formed of electrically conductive carbon nanostructures 3 preferably oriented in the current flow direction form a first region within the microscopic structure of the inner part 2a. Thermally conductive nanostructures 6 having high thermal conductivity preferably in the direction of the desired heat flow form side regions which are clearly separated from one another within the microscopic structure.

The essential reduction in size allows the design of compact encapsulated and/or shielded systems or of complete system structures. This electric component provides the possibility of designing complete transformer substations as interconnected system. The design of complete encapsulated overall systems becomes possible which, for example, can contain a number of transformers, chokes, transducers, current limiters, fusing and surveillance facilities and switching facilities.

FIG. 6 shows a sectional drawing of the surface structure and FIG. 7 shows a sectional drawing of the surface structure with a dirt-repellent nanostructure coating on one of the outside surfaces 9 of the electric component 2a.

To improve the transition of heat to the environmental medium, it is required that the surface is enlarged by a rib structure 8. According to the invention, these ribs 8 are arranged in such a manner that thermally conductive nanostructures 6 having very good thermal conductivity and high electric resistance are not only inserted into the casting compound of the winding 5a (not shown) but are arranged in such a manner that they handle the transportation of the heat into the cooling ribs 8.

The density of thermally conductive nanostructures 6 in the transition zone to rib 8 is expediently particularly high in order to achieve an advantageous ratio of the increase in the rib efficiency to the costs of the thermally conductive nanostructures 6.

To achieve a moisture- and/or dirt-repelling surface, the insertion of dirt-and/or moisture-repelling nanostructures 11 at the outside surface 9 of the casting compound is possible (similar to so-called easy-to-clean coatings). In special cases, this can also be done by means of a foil containing dirt- and moisture-repelling nanostructures 11 or a paint containing dirt- and moisture-repelling nanostructures 11. If the electric components 1a are used under water, very advantageous cooling is achieved so that additional cooling devices can be omitted.

Due to the risk of a heat-insulating layer being created by growth, fouling processes or encrustation, the coating with a dirt- and moisture-repelling nanostructure 11 prevents the above-mentioned surface processes.

Due to internal scattering effects, the short-circuit current is limited within an individual electric conductor 5a of electrically conductive carbon nanostructures 3 (not shown). By reducing the number of virtually parallel-connected nanowires of the electrically conductive carbon nanostructures 3 in a transition region, current limiting elements can be incorporated into the electric components la (not shown) in the line run, lead through or in certain areas of the electric conductors 5a.

FIG. 8 shows a top view of three electric components 1a, 1b, 1c combined to form a three-phase transformer. The cores 4 (not visible) are connected to one another by a yoke. The inside and the outside of the winding assemblies as electric components 1a, 1b, 1c are coated with thermally conductive nanostructures 6.

Due to the novel combination of different carbon nanostructures 3 and nanostructures 6, 11 and as electric components 2a, 2b, 2c, 5a, 5b, 5c, 5d, 5e, 5f of the electric component 1a, 1b, 2b, the possibility is provided to arrange the carbon nanostructures 3 and nanostructures 6, 11 in a matrix on the basis of different dopings, orientations and spatial distributions, and thus to provide a compact electric component.

Due to this configuration, it is possible, for example, to utilize the electric conductor with oriented electrically conductive carbon nanostructures 3 as alignment electrodes.

The placement of semiconducting shieldings in the inner parts 2a, 2b, 2c provides for a linkage and/or field control. Using electrically conductive carbon nanostructures 3 lowers the electrical losses in comparison with conventional conductors and, at the same time, provides for good dissipation of the heat lost to the outside. Dispensing with internal cooling media, and the high thermal stability of the thermally conductive nanostructures 6, allow the electric component 1a, 1b, 1c to be operated at very high temperatures. This increases the effectiveness of the cooling over the outside surfaces extremely.

Embedding the electric conductors 2a, 2b, 2c, 5a, 5b, 5c, 5d, 5e, 5f in thermally conductive nanostructures 6 leads to high mechanical strength of the entire inner part 2a, 2b, 2c.

At the same time, an extreme reduction in size and mass of the electric component is possible so that extremely rugged and compact electric devices—for example compact transformers of the smallest structural shape for high tension applications—can be built. In addition, the considerable reduction in size allows novel compact overall installations to be designed. Thus, compact transformer substations or compact installations of transformers, chokes, transducers, current limiters and safety facilities are conceivable with the present invention.

1-18. (canceled)

19. An electric component, comprising:
two electric connection points;
outside surfaces; and
an inner part having an electric conductor with ends, inside said electric conductor a current path having a current flow direction is specified because of said ends of said electric conductor being connected to said two electric connection points inside the electric component, said electric conductor formed from a mixture of carbon nanostructures having a preferred orientation with respect to electric conductivity along the current flow direction, and heat produced during an operation in said electric conductor can be removed to at least one of said outside surfaces of the electric component by means of said inner part, said inner part containing a mixture of nanostructures having a preferred orientation with respect to thermal conductivity to at least one of said outside surfaces of the electric component.

20. The electric component according to claim 19, wherein said inner part encloses said electric conductor at least partially.

21. The electric component according to claim 20, wherein said inner part electrically insulates said electric conductor at least partially.

22. The electric component according to claim 19, wherein said inner part has an electric shielding disposed around said electric conductor.

23. The electric component according to claim 19, wherein said inner part forms at least one of said outside surfaces of the electric component and has a structured surface for improved heat delivery to an environmental medium.

24. The electric component according to claim 19, wherein at least one of said outside surfaces of the electric component is coated with a further nanostructure having at least one of moisture-repelling characteristics or dirt-repelling characteristics.

25. The electric component according to claim 21, wherein said inner part has a polymer, wherein at least one of said mixture of said carbon nanostructures or said mixture of said nanostructures can be inserted into said polymer.

26. The electric component according to claim 25, wherein said polymer can be applied to said inner part as a foil.

27. The electric component according to claim 19, wherein said electric conductor is formed exclusively of said mixture of said carbon nanostructures having the preferred orientation with respect to the electric conductivity along the current flow direction.

28. The electric component according to claim 19, wherein a concentration of at least one of said mixture of said carbon nanostructures or said mixture of said nanostructures varies within said electrical conductor.

29. The electric component according to claim 19, wherein a concentration of at least one of said mixture of said carbon nanostructures or said mixture of said nanostructures is increased in mechanically loaded regions within said electrical conductor.

30. The electric component according to claim 19, wherein:
the electric component is selected from the group consisting of a transformer, a choke and a coil; and
said electric conductor has at least one part-winding.

31. A method for producing an electric component, which comprises the steps of:
providing an inner part having an electric conductor with ends, wherein inside of the electric conductor a current path having a current flow direction is formed because of the ends of the electric conductor are connected to two connection points inside the electric component and heat produced during an operation in the electric conductor can be removed to at least one outside surface of the electric component by means of the inner part; and
forming the inner part from a mixture of nanostructures having a preferred orientation with respect to thermal conductivity to at least one of outside surfaces of the electric component.

32. The method according to claim 31, which further comprises embedding the electric conductor into a carrier structure, the mixture of the nanostructures having the preferred orientation with respect to the thermal conductivity to at least one of the outside surfaces of the electric component being embedded into the carrier structure.

33. The method according to claim 32, which further comprises integrating a semiconducting shielding into the carrier structure as a component of the inner part.

34. The method according to claim 31, which further comprises coating at least one of the outside surfaces of the electric component with a further nanostructure having at least one of moisture-repelling characteristics or dirt-repelling characteristics.

35. The method according to claim 31, which further comprises inserting at least one of the mixture of the carbon nanostructures or the mixture of the nanostructures in a defined manner into a carrier structure by means of electrophoresis.

36. The method according to claim 32, which further comprises embedding the electric conductor into a carrier structure.

37. The method according to claim 32, which further comprises embedding the electric conductor into a polyamide structure.

38. A method for producing an electric component, which comprises the steps of:
providing two electrical connection points;
providing outside surfaces; and
providing an inner part having an electric conductor with ends, inside the electric conductor a current path having a current flow direction is specified because of the ends of the electric conductor being connected to the two electric connection points inside the electric component, the electric conductor formed from a mixture of carbon nanostructures having a preferred orientation with respect to electric conductivity along the current flow direction, and heat produced during an operation in the electric conductor being removed to at least one of the outside surfaces of said electric component by means of the inner part, the inner part containing a mixture of nanostructures having a preferred orientation with respect to thermal conductivity to at least one of the outside surfaces of the electric component.
